(19) United States
(12) Patent Application Publication
(10) Pub. No.: US 2006/0156316 A1
(43) Pub. Date: Jul. 13, 2006

(54) System and method for application specific array processing

(75) Inventor: Jerrold Lee Gray, Woodinville, WA (US)

Correspondence Address: Gray Area Technologies, Suite 340, 14241 NE Woodinville-Duvall Road, Woodinville, WA, 98072, US

(73) Assignee: Gray Area Technologies, Woodinville, WA (US)

(21) Appl. No.: 11/303,817

(22) Filed: Dec. 16, 2005

Related U.S. Application Data
(60) Provisional application No. 60/637,414, filed on Dec. 18, 2004.

(51) Int. Cl. G06F 13/00

(52) U.S. Cl. 719/328

(57) ABSTRACT

A processing architecture and methods therein for building application specific array processing utilizing a sequential data bus for control and data propagation. The methods of array processing provided by the architecture allows for numerical analysis of large numerical data such as simulation, image processing, computer modeling or other numerical functions. The architecture is unlimited in scalability and facilities mixed mode processing of idealized, analytical and real data, in conjunction with real time input and output.

### CROSS REFERENCE TO RELATED APPLICATIONS

This application is based on provisional application Ser. No. 60/637,414, filed on Dec. 18, 2004.

### BACKGROUND OF THE INVENTION

The disclosed invention relates generally to the field of parallel data processing and more specifically to a system for application specific array processing and process for making same.

Most of the parallel processing of data uses two distinct models, one is a Network of Workstations (NOW) and the other is a multi-processor mainframe computer for massive numerical data processing. In the case of Network of Workstations a software application is installed on the operating system running on these machines. The software application is responsible for receiving a set of data, usually from an outside source such as a server or other networked machine, and process the data using the CPU. Often these software applications are designed to take advantage of free or inactive processing cycles from the CPU.

All DSP(s) and CPUs are generic processors that are specialized with software (high-level, assembly or microcode). There have been attempts to create faster processing for particular identified data, one such solution is a uniquely designed Logic Processing Unit (LPU). This LPU had a small Boolean instruction set its logic variables had only 2-bit representations (0, 1, undefined, tri-state). A novel approach, but it is still a sequential machine performing one instruction at a time and on one bit of logic at a time.

In more specific types of numerical processing such as logic simulation uses unique hardware to achieve the analysis. While this is effective for processing and acting on a given set of data in a time efficient manner, it does not provide the scalability presented in the architecture presented.

One of the shortcomings of current solutions is their inability to properly coordinate data. Any network of machines that employs the use of general computing resources, for example standard personal computers, has an inherent latency in the communication between processing modules. Specialized processors or networks of specialized processors often contain proprietary interconnects and interfaces, that hinders their flexibility for processing multiple types of data or interfacing to separate processing modules. Another limitation is in their ability to appropriately scale to the data presented for processing.

Even the fastest computers based on a standard CPU architecture (I.E. x86) can be classified as general purpose machines as the processors are designed to process many different types of data and are driven from any one of the many general purposes operating systems. Because these processors must be open to handle many different operations and are often architected to handle data in a serial fashion they have low efficiency for parallel processing of large data sets. While multi-core processors and technologies such as HyperThreading™ have been introduced to provide additional processing power, these technologies are still limited in that each processing core must be passed one set of data at a time and still remain ineffective for parallel processing for large sets of specific data. The architecture presented in this invention allows data to flow to one or more scaled processors specifically configured to efficiently process a given type of data when needed for processing.

A further embodiment of the invention presented describes the methods in which the Application Specific Processor architecture can be applied to the process of Boolean simulation.

Modeling of a logic design prior to committing to silicon is either done through simulation or emulation. Simulation is strictly analytical and usually done on a conventional computer. Emulation requires specialized hardware programmed with the model under test and may or may not be connected to real world (real time) devices for input and output. Isolated emulation is still considered analytical and the hardware is a simulation accelerator. When connected to the real world it is often referred to as logic validation since real world behavior can be evaluated.

Emulation and validation is very expensive but can process the model several orders of magnitude faster than simulation. Emulation hardware functions like the actual circuit which will have thousands of machines (millions of transistors) concurrently functioning. Simulation, on the other hand, is a sequential analysis of each machine in its own circuit on a one-at-a-time basis on general purpose computer hardware/software. Parallelism and concurrency are more difficult, and expensive, to accomplish with conventional computers, microcontrollers, DSP(s) or other generic hardware.

Cycle base simulators are useful for accelerating all simulations regardless of design size. At high gate counts, even cycle based simulations on a single CPU have a severe performance penalty. Simulation designers have used a variety of techniques to create a network of machines for a single simulation.

Software designed to simulate high level language representations of logic are often developed on a standard system Central Processing Unit (CPU). While this provides a ubiquitous platform for developing applications to process numerical data, simulate or other analysis, the CPU is often shared with the operating system and other applications executing. The application driving the data processing is performed in a serial fashion and has to wait for one point to be analyzed, returned, then determine if there the next set of data needs to be processed.

One method presented in this invention is to augment the CPU such that is operates on a reduced sum-of-product representation of a multi-variable logic, referred to as Logic Expression Table (LET's)

Yet another key element presented in this invention is the ability to understand and process the operational structure of logic, allowing for faster data processing when performing actions such as synthesis.

### BRIEF SUMMARY OF THE INVENTION

The primary object of this invention is to provide a computational architecture for processing of data sets.

Another object of the invention is to provide data specific processing through implementation of an array of application specific processors.

Another object of the invention is to provide an extensible architecture for the parallel processing of data.

Another object of the invention is to provide a data bus capable of allowing the data to propagate to and from all available processors.

A further object of the invention is to provide a method for faster simulation of Boolean expressions.

Yet a further object of the invention is to provide a means for an application to provide data for processing.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a system for application specific array processing comprising: a host hardware such as a computer with operating system, a data stream controller, a computational controller, a data stream bus interface, an application specific processor, and a device driver providing a programming interface.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a block diagram of a computing system with the Computational Engine included.

FIG. 2 is a block diagram of the Computational Engine PCI plug-in card with logical modules.

FIG. 3 is a block diagram of the overall software architecture

FIG. 4 is a flow chart of the operations that comprise the method of the Application Specific Processors.

FIG. 5 is a diagram illustrating the Vector State Stream bus architecture.

FIG. 6 is a diagram illustrating the operation of Input and Output of individual devices from the Vector State Stream Interface.

FIG. 7 is a schematic block diagram of the Vector State Stream hardware interface.

FIG. 8 is a flow chart of the operations that comprise the Digital Stream Bus Interface Read and Write Operations.

FIG. 9 is a block diagram of the Application Specific Processor Interface.

FIG. 10 is a flow chart of the startup and computational process.

FIG. 11 is a flow chart of a computational cycle

FIG. 12 is a diagram illustrating the Vector State Stream architecture for Boolean Simulation.

FIG. 13 is a flow chart of the operations that comprise the method of the Logic Expression Tables for Boolean Simulation.

FIG. 14 is a block diagram of the Application Specific Processor Interface configured for Boolean Simulation.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

This invention presents a universal method for connecting an unlimited number of processors of dissimilar types in a true data-flow manner. This method of the Vector State Stream (VSS) and its use of a Delimited Data Bus allow data to physically propagate from general memory to a processor designed for optimum processing of that data and back into general memory.

This allows the propagation of logical vectors and scalars as well as single, double and quadruple floating point numbers with equal ease among or between different mathematical or logical disciplines. As a sequential bus, there is no physical limit on how many entities may be on the bus. This in turn allows enormous arrays of mixed mode processing of data suited to this scheme. The scope of this invention becomes apparent when one considers that a large enough collection of special purpose processors can create a more general purpose environment.

Toward this end, the preferred embodiment of this invention must be application neutral physically and allow the definition of universal methods of data propagation and control. Development of application specific elements on top of these universal methods then allows mixed mode operation for very specific or broader applications.

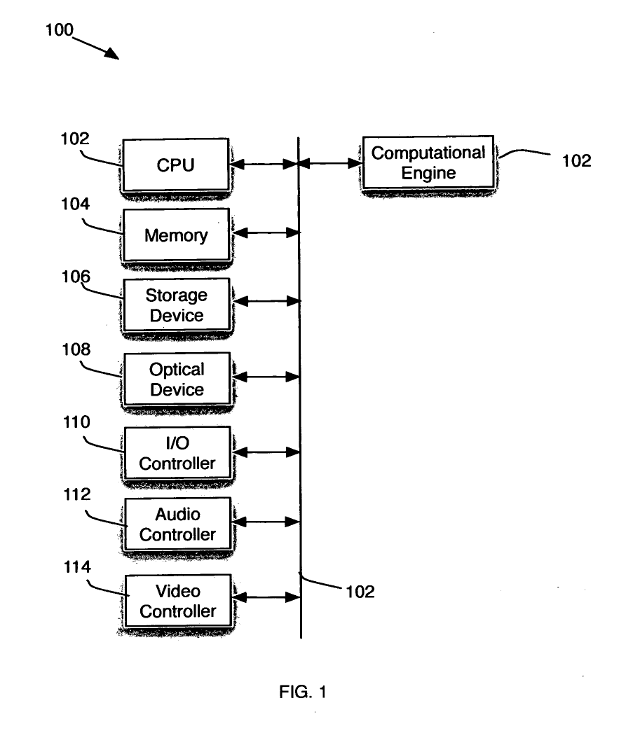

In a preferred embodiment of this invention a conventional computer system 100 (FIG. 1) is host for the PCI card referred herein as the Computational Engine 116, which is populated with among other modules a computational controller 214, SDRAM 210, and an array of Application Specific Processors 220,222,224 (referred to as ASP) hardware. The Computational Engine 200 is the integrating environment for both hardware and software. The process described in this invention is known as Application Specific Array Processing (ASAP). This embodiment can have one or more conventional PCI plug-in circuit boards standard in computer platforms.

Other embodiments will house a conventional host CPU in enclosures and power supplies suitable for high-end performance. Host CPU bus standards may include standards other than PCI.

Another embodiment this invention presents is a system and process for networked Application Specific Processors, which approach the parallelism/concurrency of emulation systems without the inherent restrictions on scalability. It will become evident from the invention description that the networking method allows dissimilar machines on the network and allows interfaces to the real world for validation. Finally, the system presented is extensible in the compiler and in the executing machines with no penalties.

The scalable array of processors is supported by a stream of data representing variables that flow from ASAP memory which is implemented using SDRAM, through all of the ASP processors memory (dual port RAM), and back into ASAP memory. An embodiment of this data stream bus will be 32-bit+control that propagates from processor to processor in a daisy chain manner. This will be conventional CMOS logic when confined to a single PCI card though can be converted to LVDS when extended to other PCI cards. Other embodiments will use larger word widths, LVDS within PCI cards and high performance LVDS or optical interconnects between PCI cards.

Low Voltage Differential Signaling (LVDS) refers to instead of having one logical bit as a 3.3 Volt signal on one pin; we have a signal as two opposite phase signals on two pins. Low voltage means instead of having 3.3 Volt swing on each pin, it is only 2.5 Volts or 1.2 Volts in current I/O standards as well as other low voltage levels in future standards. LVDS has advantages in that are both more resistant to noise and also less of a noise generator. It can run at significantly higher clock rates over longer distances.

The Data Stream Computation Controller (DSCC) 214 provides cycle-by-cycle control of data streaming from SDRAM 210 to the Data Stream Bus, supporting all defined delimiters, through the array processors 220, 222, 224 and back to SDRAM 210. The DSCC controller 214 can be Field Programmable Gate Array (FPGA) or an Application-Specific Integrated Circuit (ASIC) implementation.

One knowledgeable in the field will understand the differences between FPGA and ASIC, as the differences and engineering decisions between them are well known. In a simple implementation of the DSCC 214 it would support only the few protocols sufficient for processing first models (such as Vector State Stream protocol for simulation). More complex embodiments of this will support a multiple or a super-set of protocols that will allow simultaneous support more than one type of data processing.

The DSCC 214 also allows applications executing on the host system 100 to access the SDRAM 210 used in ASAP processing as well as direct or indirect programming and control of all of the individual processors in the ASP array. In this embodiment the DSCC 214 is a master controller and all other processing entities on the data stream bus are slaves, even if they originate data.

The Data Stream Bus Interface (DSBI) provides the interface between the data bus and the array processors. The Data Stream Bus Interface is implemented as an FPGA or ASIC, often coupled in the same processor as the DSCC 214. The DSBI is a slave controller.

The bus disclosed in this invention is a sequential bus with delimiters intermixed with data. A delimiter defines what the next data is so that the receiving entity can respond accordingly. If the delimited is understood by the DSBI it will process bus words as 32 variables of 2-bit data. The delimiter establishes a starting address. If the leading address doesn't match a value assigned to the DSBI, it counts objects until it does.

If the delimiter is not understood by the DSBI, it ignores but passes one data to the next entity on the delimited data bus until it sees the next delimiter.

The Vector State Stream (VSS) is the actual data set that propagates on the bus and represents a complete set of data for one computational cycle. The data could be logic data for simulation or processing, but it could also be floating point data for numerical analysis, statistics, filtering or a number of other operations. In this latter case it would be termed a sample state vector. The stream property is merely the serial format the data takes in propagating on the bus.

The embodiments of the Application Specific Processor (ASP) are as varied as the number of overall applications for the whole system. Low and high-end embodiments will differ in degree of cost/performance for the same application type. Some embodiments will be unique new designs for logic. Eventually other ASP built from new design and/or pre-existing technology ICs (DSP(s), PIC or other processors); Verilog IP (RISC, DSP cores in FPGAs/ASICs) could and will be adapted to an ASAP process.

For logic ASPs part of the instruction of the Boolean Processing Unit (BPU) contains entries in a Logic Expression Table (LET). The LET is a table of binary numbers for N logical variables represented at 2-bit data. The table consists of I input variables and O output variables where I+0<=N. The input variable 2-bit data values “0”, “1” and “2” are defined as “0”, “1” and “don't care” respectively. The output variable 2-bit data values “0” and “1” are defined as “not included” and “included”.

Combinatorial logic can always be reduced to what is known as a Sum of Product (SOP) form. It is well known that multiple output logic in the same module, if express in SOP form, also has shared terms. The “input” side of the LET is a list of all the product terms in a given module. Any input that is not used in a product term is defined as “don't care”. Any input defined as “0” or “1” is an input to a product term in inverted or non-inverted polarity respectively. The output side of the LET is simply whether or not the input product term on the same line is included in evaluating the output.

At compile time, LET entries get included with special instructions to the BPU that efficiently match a current set of modular inputs to the input side of the LET. By this means multiple outputs get evaluated in parallel with great efficiency.

A conventional computer system (FIG. 1) contains various components which support the operation of the PCI Computational Engine 116, these components are described herein. A typical computer system 100 has a central processing until (CPU) 102. The CPU 102 may be one of a standard microprocessor, microcontroller, digital signal processor (DSP) and similar. The present invention is not limited to the implementation of the CPU 102. In a similar manner the memory 104 may be implemented in a variety of technologies. The memory 104 may be one of Random Access Memory (RAM), Read Only Memory (ROM), or a variant standard of RAM. For the sake of convenience, the different memory types outlined are illustrated in FIG. 1 as memory 104. The memory 104 provides instructions and data for the processing by the CPU 102.

System 100 also has a storage device 106 such as a hard disk for storage of operating system, program data and applications. System 100 may also include a Optical Device 108 such as a CD-ROM or DVD-ROM. System 100 also contains a Input Output Controller 110, for supporting devices such as keyboards and cursor control devices. Other controllers usually in system 100 are the audio controller 112 for output of audio and the video controller 114 for output of display images and video data alike. The computational engine 102 is added to the system through the PCI bus 102.

The components described above are coupled together by a bus system 118. The bus system 118 may include a data bus, address bus, control bus, power bus, or other proprietary bus. The bus system 118 may be implemented in a variety of standards such as PCI, PCI Express, AGP and the like.

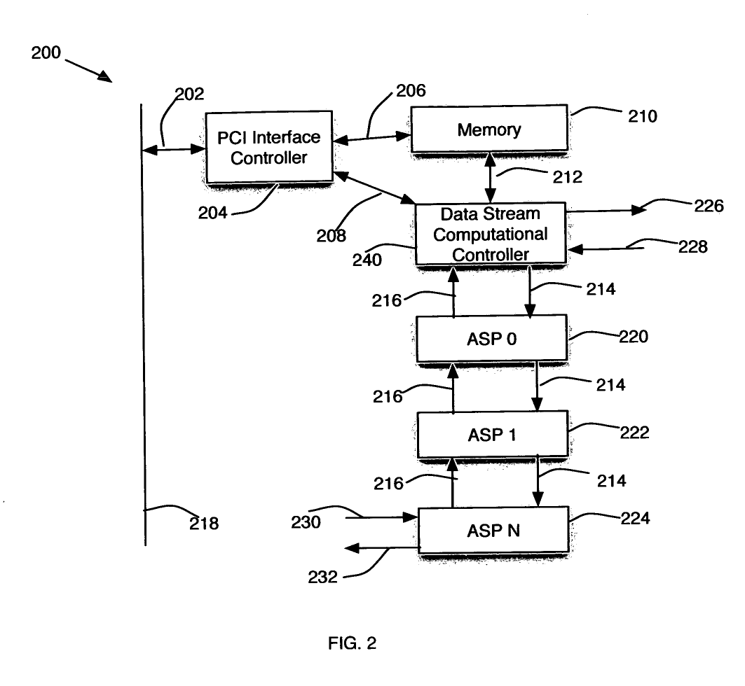

FIG. 2 shows the logical modules of the Computational Engine PCI card. For direct control the computational memory 210, controls and status can be mapped into the PC's addressable memory space 104. The computational memory 210 only contains the current and next values of the computational cycle. Contiguous input data and contiguous output data would be sent to the CE from the application from a hard disk 106, or system memory 104. The data and delimiters what are written 206 to computational memory 210 and are managed by the application executing on the system 100. During initialization ASP instruction and variable assignment data images are written 206 into computational memory for later transfer by the DSCC 240.

Prior to a computational cycle, new inputs are written 206 to the computational memory 210. The inputs may be from new real data or from a test fixture. After the computational cycle newly computed values can be read out 206, 202 for final storage.

The application 300 can interact with the DSCC controller 240 to trigger the next computation or respond, by interrupt to the completion of the last computation or the trigger of a breakpoint of the occurrence of a fault, for example a divide by zero. In this embodiment the computational controller 240 is a specialized DMA controller with provisions for inserting certain delimiters and detecting others of its own. It is responsible for completing each step in the cycle but the cycle is really under control of the host software.

The outbound data bus 216 is new initialization or new data for processing by one of the ASP's chain. The inbound data bus 218 is computed data from the last computational cycle or status information. During initialization it also provides information on the ASP types that are a part of the overall system.

In the event that this CE is a slave to another CE its own DSCC and SDRAM become dormant and the outbound data bus is merely the outbound data coming in from the master CE. Similarly the inbound data bus to the master CE is the inbound data bus to this module.

The system can contain an inbound 226,230 and outbound 228,232 data bus option to and from a slave mode ASP CE. This allows more than one PCI card to be installed in a host system, whereby one is the primary CE and the second CE acts a slave to the primary.

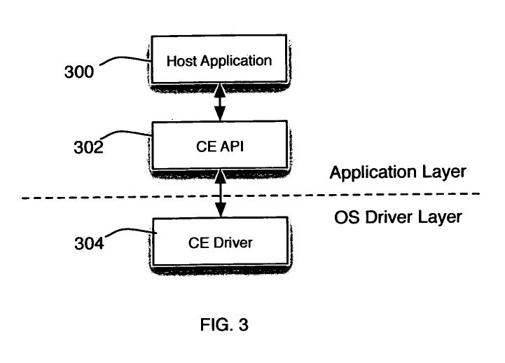

FIG. 3 presents the software architecture on a host machine used to drive the DSCC 240 ASP's on the CE 200 cards. 302 is library which exposes Application Programming Interfaces (API's) for the application 300 to invoke in order to present data for analysis. 304 is the primary driver for converting the application data request to the data models needed for the CE. Using a compiler which can feed a synthesis backend we can generate a series of LET's.

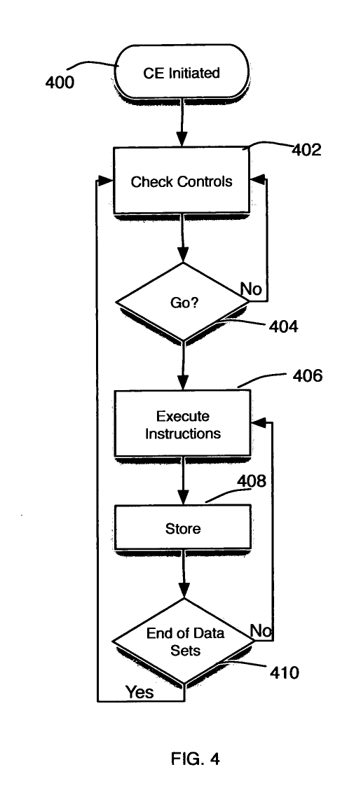

The CE is initialized through the PCI interface step 400, the ASAP process next checks the controls 402 for it's set of actions (FIG. 4). The ASP is a processor in a polling loop waiting for a Go bit 404 or value to be written to either a register or a special dual-port RAM location. When it sees a Go 404 it executes code step 406, stores the results in the SDRAM step 408 and when is get to the end of the data sets 410 it processes a done status and returns to the polling loop.

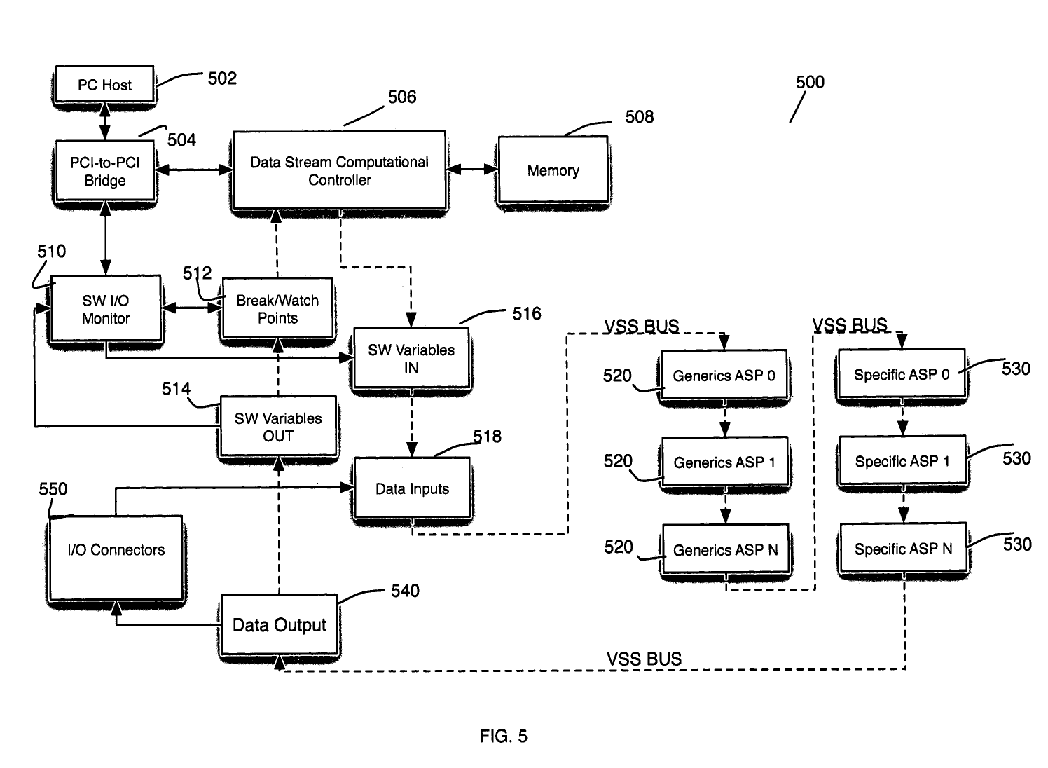

FIG. 5 is a functional diagram illustrating the Vector State Stream bus architecture. The system contains a PC host 502 with a least one PCI slot with the Computational Engine PCI card 200 plugged in. The PCI interface 504 includes hardware PCI-to-PCI, bridge to isolate the host PCI bus when the lead DSCC FPGA isn't programmed. Once programmed the main DSCC memory 508 controls can be mapped into the hosts PC's memory space 104 and visa versa. The source of high level computational control from the host application 300 is through interaction with this low level DSCC 506 along with data written to and read from the SDRAM 508. Buffer transfers to and from SDRAM 508 are through DMA channels or through I/O functions. Interaction with the DSCC controller 506 is event driven. A software monitor and Input/Output module 510 is coupled with the main DSCC controller 506 is provided for complex simulation or analysis which require high speed interaction with software that might be slower if using the SDRAM interface. The software monitor and I/O module 510 allows access to the VSS data stream by providing breakpoint and watch point functions.

A memory pool 508 is SDRAM or any other high speed DDR. This memory pool is used by the overall ASAP process. With this flexibility in the memory architecture there is no restriction on the bus size and can be hundreds of bits in width for high performance needs.

Break and watch points 512 are a mechanism to respond to select variables in the system for critical conditions or simply a meaningful change in state. The difference between the two is that a break point will halt operations, where a watch point is a method to passively monitor a variable as directed the host application 300 or active monitoring by interrupt.

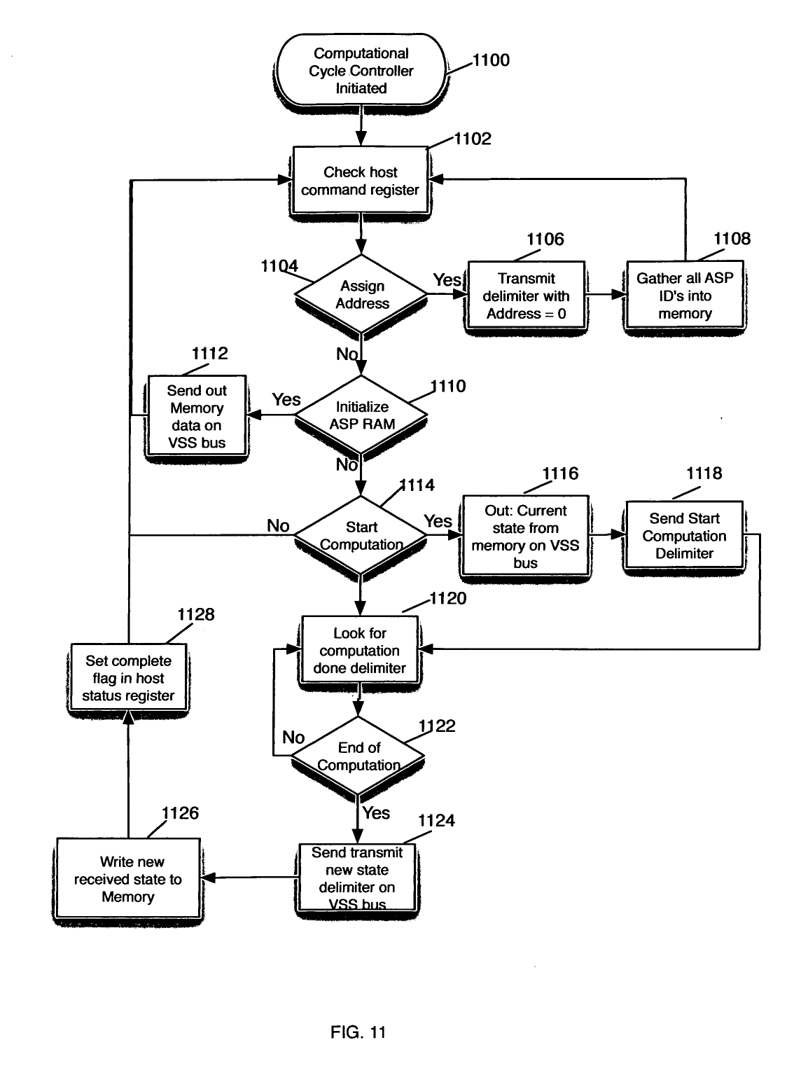

The software variables in 516 and out 514 interfaces are provided such that the application 300 can feed data into or extract data from the end of a given computational cycle respectively. The real input 518 and output 540 modules provide a high-speed interface between the real world and the computational process. These interfaces are all digital and the digital numbers could be anything from basic integers to quadruple precision floating point numbers. The generic ASP 520 represented in this diagram is the basic processor type used in the majority of the computational process (FIG. 11). This processor 520 is configured and used regardless whether the computational data is logic patterns, matched filters, or fast flourier transforms. The ASP's 520 are represented in FIG. 5 as derived from an FPGA pool, it is also understood that as routines data process is defined they may reside in ASIC form. The special ASP's 530 can be configured as unique to the processing application data or configured as a common machine that only provide cursory processing of data.

The VSS bus is a sequential bus and does not inherently depend on bus width or whether or it is CMOS or Low Voltage CMOS or LVDS logic levels. To simplify the diagram and facilitate understanding its function, the return path of the VSS bus is to the DSCC 506 from the Break/Watch point module 512. A further implementation of this embodiment would have the return path is a second in-bound bus retracing back through all the modules.

The VSS bus cycles have essentially four phases of read, compute, write and optionally maintenance. Input and output devices usually won't have anything to do during the compute cycles. All devices will need to interface to this high-speed bus on the order of one bus word per clock cycle. In FPGAs the maximum internal clock speed is around 300 MHz which limits implementation at those frequencies to the simplest of structures. Gate arrays, Standard Cell and custom ASICs are operating in the neighborhoods of 500 MHz, 1 GHz and 3 GHz respectively.

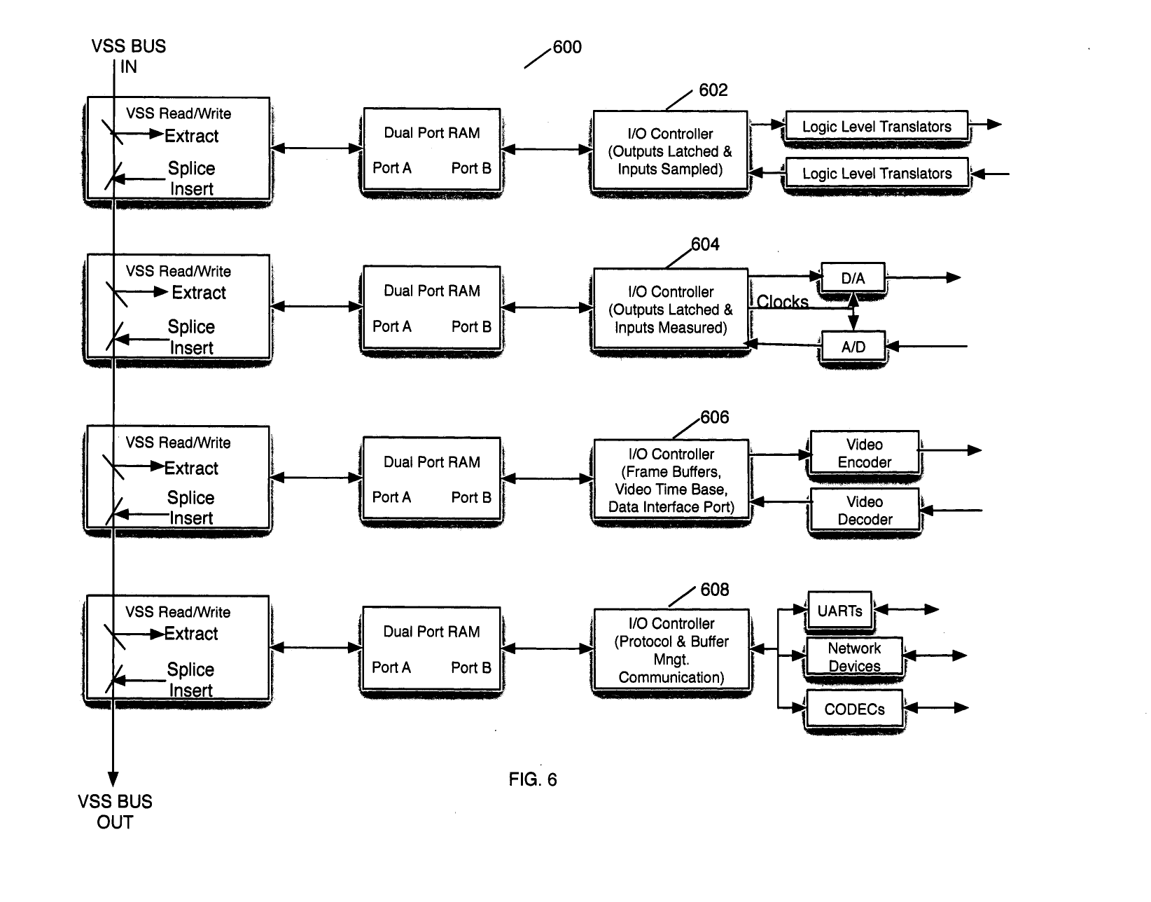

FIG. 6 is a diagram illustrating the operation of input and output of individual devices from the vector state stream interface. This is a diagram further defines the scope of possible ASPs related to system input and output. Various forms of ASP can be employed to interface digital processing to real world devices. Arbitrary external logic 602 can be driving or read from arbitrary external logic with logic level translators. This form of ASP is responsible for mapping output variables in dual port RAM to output pins and input pins to variables in dual port RAM. Other logical input and output pins in this module are used as clocks or clock indicators to cleanly clock data into or out of the module with synchronization to the simulation or computational cycle.

Basic arbitrary interfaces to the analog world are indicated 604 with an Analog to Digital (A/D) and Digital to Analog (D/A) converters. Though the interface to these is a standard logic level, the I/O has some rigorous timing requirements on synthesis and sampling clocks, which must be provided by this ASPs module. This module can contain simple sampling and output generation, it can also include higher level functions of digital filter and over-sampling and produce or consume floating point rather than integer numbers.

More demanding analog I/O 606 such as video encoding and decoding involve rigorous timing standards, which aren't likely to be sustainable by computational throughput. An ASP of this type supports a time base compatible with the video standard and frame buffering so that images can be input and output at the standard rate and processing I/O is done at a rate within the computational bandwidth of this architecture.

Since the ASP can be as complex as it needs to be, there really isn't any limitation on digital interfaces. The module 608 shown here is to illustrate that in addition to rigorous timing the module could handle complex protocols from physical to virtual circuit level protocols.

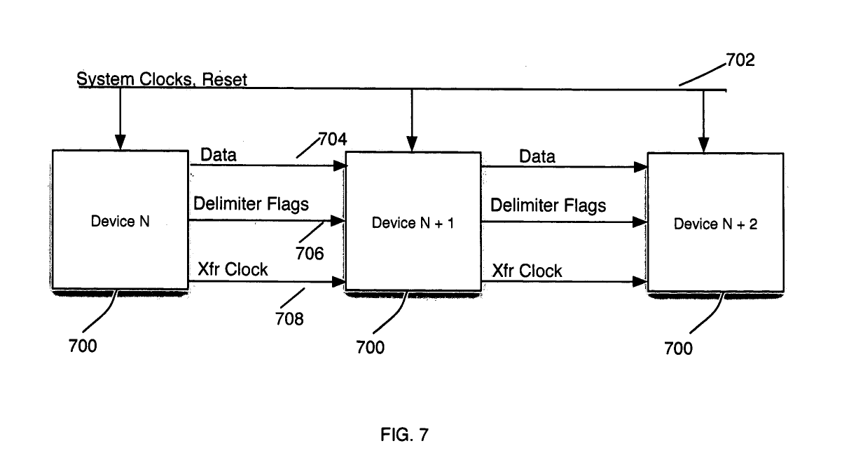

FIG. 7 is a schematic block diagram of the Vector State Stream hardware interface. In this diagram the device 700 is implemented as either an FPGA or ASIC which contains multiple ASP's. The input/output to the device 700 is one data stream either outbound or inbound, since at this level their behavior is identical. There are one or more clocks 702 in the system at the board level as well as the system reset to coordinate all the devices in the system. The data bus 704 can be either 16-bit, 32-bit, 64-bit and a high speed LVDS. The data field on the bus runs in parallel with the delimiter data field 706. The delimiter field 706 is a multi-bit quantity that identifies what the data field 704 means. The transfer clocks 708 are clocks that are in phase with the output data. The use of these clocks is optional when transferring data from module to module on the same CE board since the phase of the data can be determined by the global clocks.

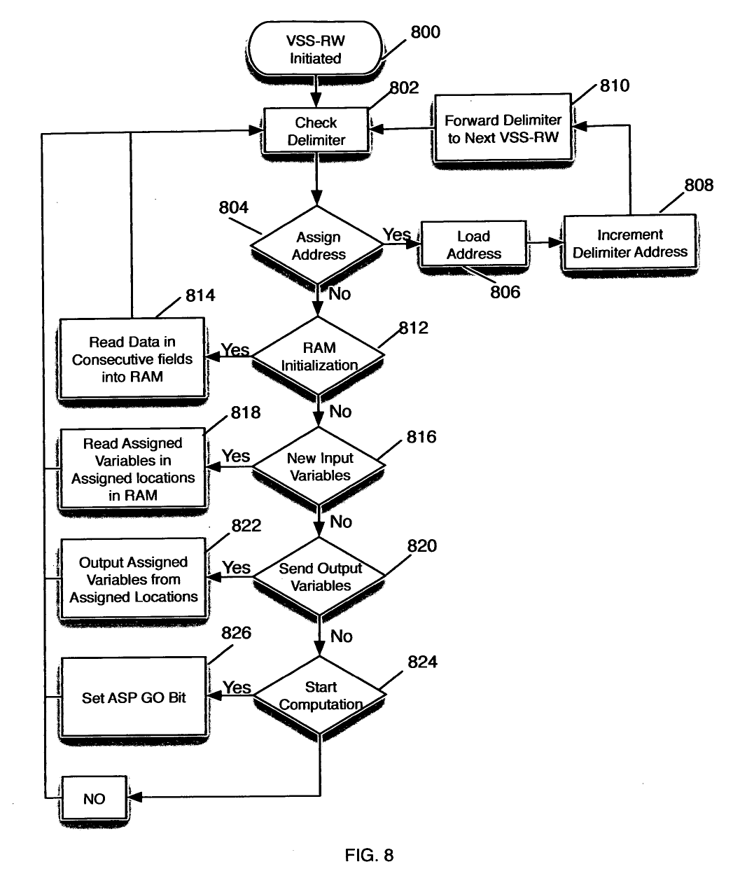

A flow chart of the operations that comprise the DSBI read and write operations is illustrated in FIG. 8. The DSBI module in initiated 800 as a slave device that passes all delimiters and data is sees on the VSS to the next ASPs DSBI module. The one exception is during ASP initialization phase, address assignment delimiters detected 804 have the address field incremented 808 after current value has been loaded 806, then the incremented value and delimiter are forwarded to the next VSS read/write 810.

When the RAM initialization 812 delimiter is recognized the ASP address previously assigned is compared with the initialization delimiter address to select the data 814. Some initializations are global and some are ASP specific.

After RAM initialization, the DSBI will watch 816 for delimiters to load new input variables 818, send output variables 802 and step 822 or to start a computation 824 and step 826 to calculate output variables.

The VSS read write module 902 is a slave controller that responds to the delimiters on the VSS bus primarily to extract variables prior to calculation and splice-in or overwrite resulting variables after calculation. Administration delimiters are supported to allow the ASP's to report themselves after initialization, accept address assignment, load instructions and constants, along with any maintenance functions. The dual port RAM 904 is a block of 1 to 4 instances of Xilinx Synchronous Random Access Memory (SRAM) or an arbitrary sized block of ASIC SRAM. Each port has its own address and data bus as well as control signals and even separate clocks such that both the VSS Read/Write controller 902 and the ASP 906 can independently access any location in memory. The ASP 906 is configurable based on the data set being passed in. The ASP 906 can be a conventional processing machine with a program counter and executing instructions in the dual port RAM 904 and operating on variables in the RAM 904. The ASP could also be configured as a mathematical processor or autonomous processor.

The configurability and the value to process unique and diverse data sets has been disclosed throughout the invention. Within the VSS bus architecture there is a provision at the processor level to bypass 908 unused ASP's in the chain of those available. For data sets that are smaller than the ASP's available, the bypass 908 is a mechanism to reduce processing time by eliminating unnecessary stages in the bus process.

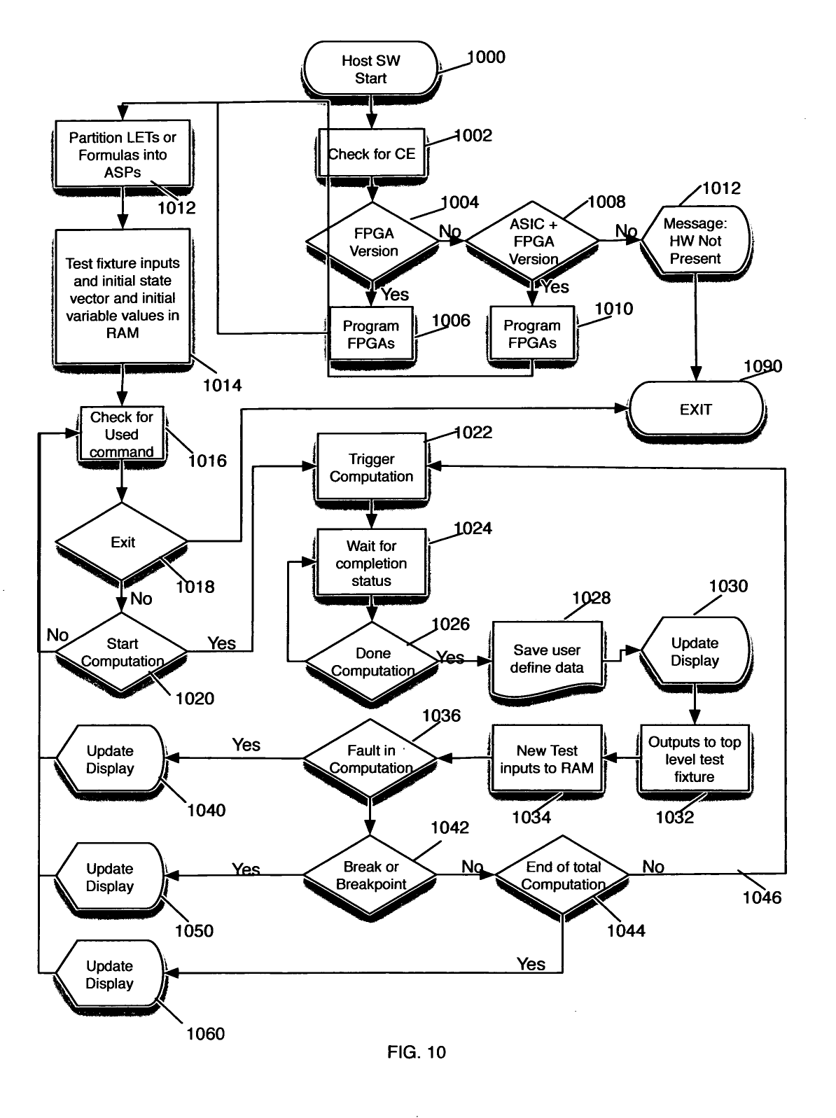

In accordance with the preferred embodiment, FIG. 10 is a flow chart of the host software and its interaction with the CE board. The end user software can be a feature rich GUI application or script interfaces for running computational analysis that is outside the scope of the flowchart described herein. To simplify description this diagram includes a minimum set of operations needed for general computation, but does not limit this invention in any way. The diagram assumes a human interface that waits for a start and can accept a user break command. Obviously, these inputs would be missing in a script interface. Host software must start up and initialize itself 1000. Software must determine 1002 what type of CE hardware has been plugged into the system. If low level CE firmware is functional, a specific CE device will enumerate itself on the PCI bus. If there is no CE hardware present 1012, a message is generated and exits 1090. If an all-FPGA type CE board is present 1004, all ASPs must be programmed 1006 with a population of ASPs that will be needed for the problem at hand. All FPGA boards will be SRAM based logic programmed with block images from host files. Host software will have control over which blocks to pick for each FPGA but not any finer grain selection of ASPs within each block. If a mixed ASIC/FPGA board is present 1008, either by looking up the ID or polling via an address assignment process, host software can determine how to program the FPGA portion for ASPs 1010 needed that are not supported in the ASICs or just adding like processors to the system. Based on the number and type of ASP present, host software will partition the processing and initialize the ASPs with code 1012, constants and parameters and will assign variables or portions of the data set for the ASP to process.

The entire model, including test fixture 1014, is initialized to their first values. There is a wait loop for user input 1016. If the user generates a start 1020, the system triggers 1022 the DSCC 240 on the CE board 200 to do one cycle. Cycle could be next Boolean vector, real time logic events, and next calculation for unit time or whatever the process needs. Next there is a decision to either poll 1024 the CE board status register for completion 1026 or wait for an interrupt. Out of the new set of data, we read out and save to disk 1028 variables identified as output. Where a display is used 1030, we update any output variables appearing on the display. Outputs that are needed by the top-level test fixture 1032 are applied to that test fixture. 1034 new inputs from the test fixture applied to CE board. If there was a fault 1036 (divide by zero, bad vector, ASP crash, etc.) generate message 1040 and wait for new command. If there was a user initiated break 1042 in the application 300 or a user programmed breakpoint triggered, generate message 1050 and wait for new command. If the process is finished 1044 with the entire computation process, generate a message 1060 that we are done to the user and wait for a new command. Otherwise, 1046 continue the process into the next cycle.

FIG. 11 is a functional flow chart of a computational cycle. The VSS Read/Write module is a slave device on the VSS bus, the DSCC is the master device. It is a very small micro controller capable of initializing and starting DMA-like operations that take blocks of SDRAM data (at sequential addresses) and transfers them out on the VSS bus. Since DSCC operation is determined by software its operation includes, but is not limited to, the three types of operations shown here. These steps include a maintenance function (address assignment), a single step I/O process to the ASPs (ASP RAM initialization) and a multi-step computational cycle. After hardware initialization, software loads the DSCC with code and parameters needed to perform its basic operations step 1100. DSCC monitors a register maintained by the host for a command step 1102. If the host command is for address assignment 1104, then the DSCC puts the address delimiter on the out-bound VSS bus with the address value field set to zero step 1106. In step 1108 the DSCC monitors the in-bound VSS bus for detection of the address delimiter coming back from the ASPs. The delimiter's address field will contain the count of the number of ASPs in the system. Data fields following the delimiters will contain the Ids of all the ASPs in the system, which will be read into a block of SDRAM memory, which can subsequently be read by the host software.

If the host command is a block write to initialization ASP RAM 1110 the DSCC simply transfers a block of SDRAM pointed to by host software out onto the VSS bus 1112 for however many words are in the host command. In this type of block transfer, the host supplies one or more delimiters at appropriate points in the buffer. Initialization can be global (all ASPs get the same 2K of initialization) or it can be ASP specific. The DSCC is blind in this respect and is just a block transfer device. Initialization contains ASP instructions, parameters (variable assignments), and constants. Though not illustrated a block read would be similar, although one ASP at a time.

In step 1114 if the host command is to run a simulation cycle, the DSCC begins by putting out one or more blocks of current state variables onto the out-bound VSS bus until entire state is transmitted 1116. This step operates in a similar manner to initialization in that delimiters originate from the host and all the DSCC knows is the start location and size of the current state variables.

Once the current state is transmitted, the DSCC puts out a start computation delimiter on the out-bound VSS bus, step 1118. In step 1120 the DSCC monitors the in-bound bus for indications that all ASPs have finished their computation 1122. In step 1124, the DSCC sends out one or more delimiters to command the ASPs to transmit their output data. As new data come back to the DSCC on the in-bound VSS bus, the DSCC transfers the data to SDRAM by a formula established by host software in step 1126. After the last data is read into SRAM, the DSCC signals host software with a completion flag and an interrupt in Step 1128.

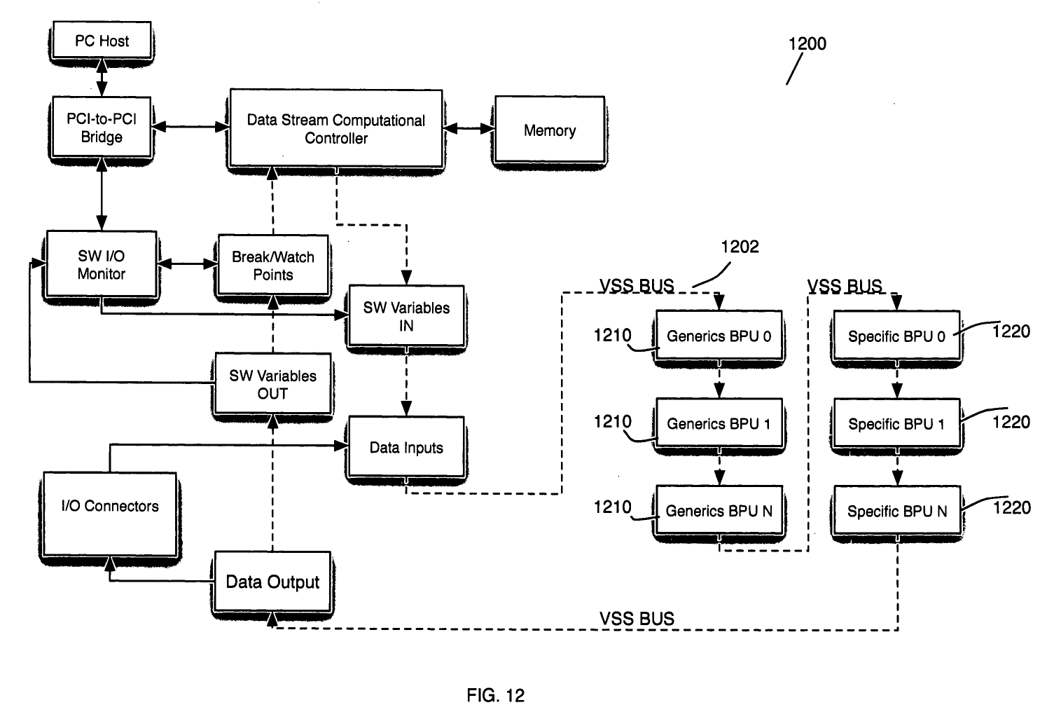

FIG. 12 is a diagram illustrating the Vector State Stream architecture for Boolean Simulation. This is a specific embodiment of the architecture outlined in FIG. 5. In the Boolean logic simulator embodiment, is built from the same physical FPGA platform or an application specific ASIC/FPGA version. Bus protocols are such that both can be mixed in the same VSS environment. There are several application specific differences from FIG. 5 which are focused on and presented in detail below.

The VSS bus 1202 is a sequential bus and doesn't inherently depend on bus width or whether or not it is CMOS, Low Voltage CMOS, or LVDS (Low Voltage Differential Signaling) logic levels. In the Boolean embodiment data propagates on the bus in the form of words made up of two bit 2-bit data representing a logic state. A 32-bit bus contains 16-bits of logic, a 64-bit bus contains 32-bits of logic and so on. Though the return path to the computational controller is shown to be directly from the Break/Watch point module a more practical structure is that the return path is a second in-bound bus retracing back through all the modules shown. The bus was not drawn in this fashion to simplify the diagram to facilitate understanding the relevant points.

The Generic BPU (Boolean processing Unit) 1210 is responsible for executing LET (Logic Expression Tables) in dual port RAM, which are its instructions, executed in standard computational manner. Current state variables in dual port RAM are converted in the next state values by execution of LET instructions.

The Special BPUs 1220 are responsible for other forms of Boolean processing. Scalar operators such as counters, multipliers, floating point units, data selectors, address encoding/decoding, adders, sub tractors, and comparators would qualify as “special”.

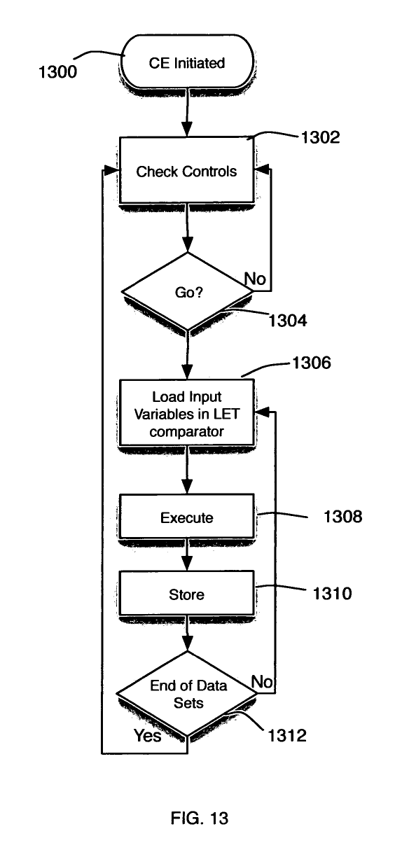

FIG. 13 is a flow chart of the operations that comprise the method of the Logic Expression Tables for Boolean Simulation. The CE must first be initiated 1300, and the first step is to check the controls 1302. Like all ASPs the waits for a “Go” indication by polling a specific register, or a specific location in dual-port RAM, maintained by the DSBI. Once triggered 1304, the BPU begins loading the comparator with the current state variables in the data set 1306. LET instructions are applied against the comparator which tests the current state variables against the LET product terms 1308. Completion of LET execution is fully deterministic and with completion all the outputs are resolved. The BPU then moves the next state variables to dual port RAM 1310. If there are no more data sets the process set a done status 1314 and returns to the polling loop. Otherwise the BPU advances to the next data set.

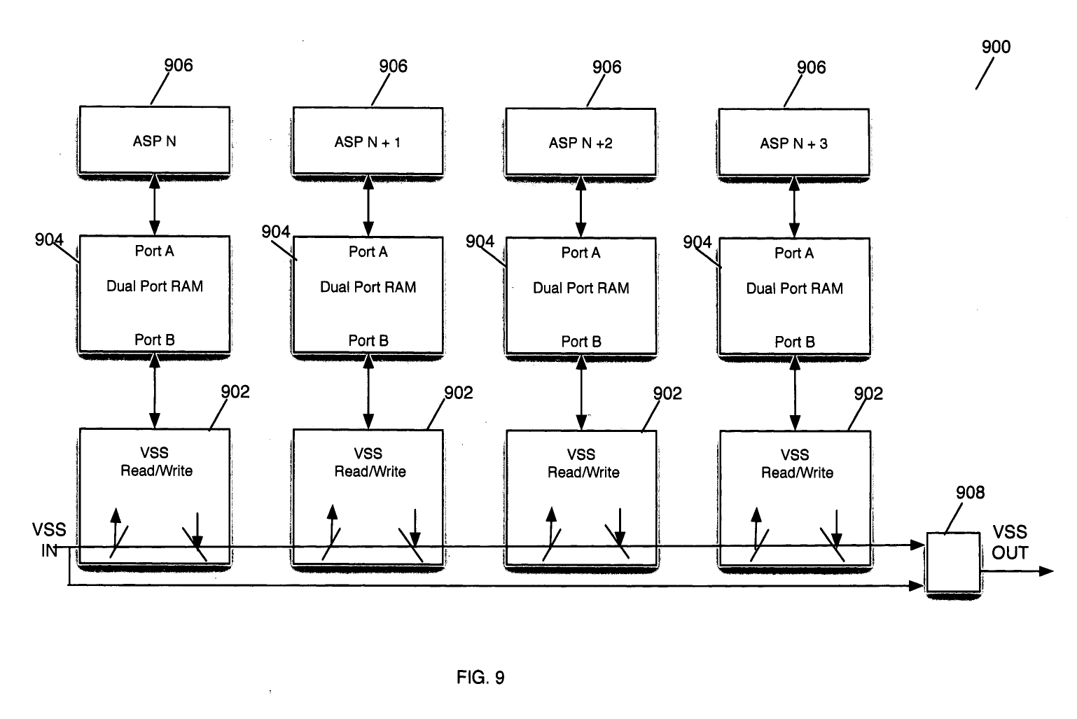

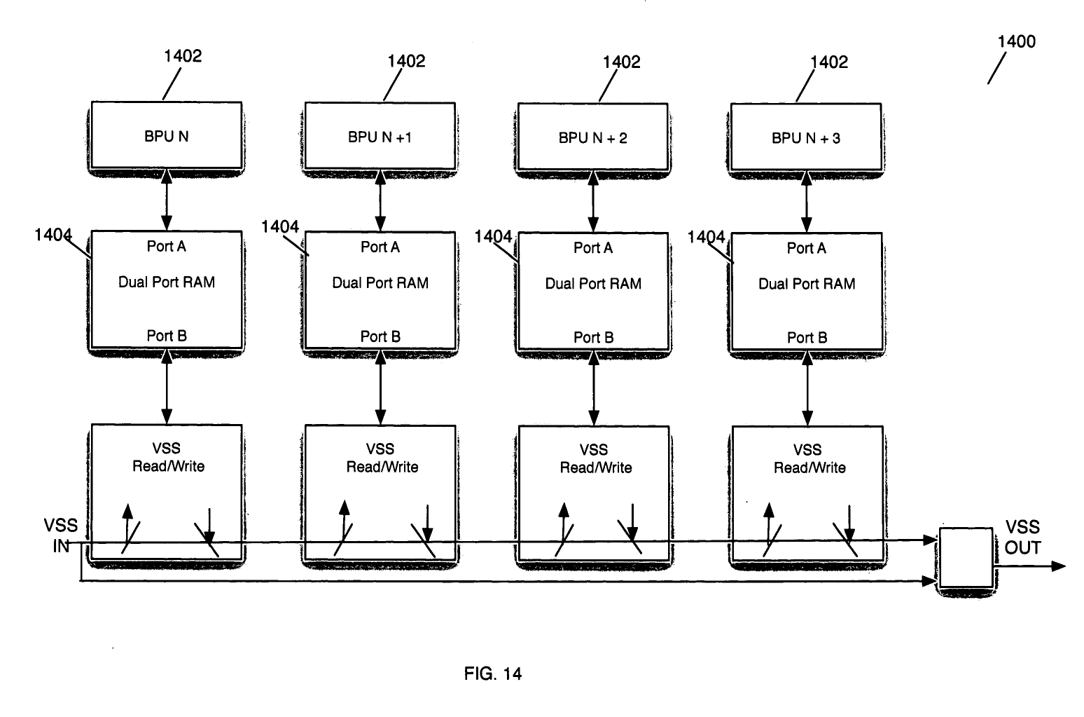

Application Specific Processor can be configured for Boolean simulation FIG. 14. This is the same illustration as provided in FIG. 9, and provided is the description of the key differences in implementation, all other descriptions of the system remain the same. This is a Boolean simulator specific embodiment of FIG. 9 with specialized implementation. In this embodiment of the architecture the generic BPU 1402 contains a processor with a very small conventional instruction set with the addition of new instructions unique to this invention. These are mapping instructions to move input data to and from the LET comparators within the BPU and instructions to execute the LET entries (as instructions) themselves.

These LET instructions are similar in their role to conventional software in that there is fixed code that can operate on more than one set of data. It is common in logic design for there to be many replications of functional logic but connected to different data. In this architecture more than one data set (current and next state) could be assigned to the same BPU. The dual-port RAM 1404 in FIG. 9 is too non-specific to allow labeling for content without inferring restrictions. In the case of Boolean simulator embodiment this can be reduce to LET and conventional instructions for the BPU and input/output variables and possible a stack. Intermediate variables are calculated from inputs but are not output directly. They are used in subsequent operations to produce output variables and may represent shared terms in Boolean equations.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A system for application specific array processing comprising:
a host hardware such as a computer with operating system;
a data stream controller;
a computational controller;
a data stream bus interface;
an application specific processor; and
a device driver providing a programming interface.

2. A method for a data processing in a system for application specific array processing
an application providing data;
a data stream controller;
a computational controller;
a data stream bus interface;
a delimited data bus;
an application specific processor; and
a device driver providing a programming interface.
